(19) United States
(12) Patent Application Publication
(10) Pub. No.: US 2014/0060883 A1
(43) Pub. Date: Mar. 6, 2014

(54) HORIZONTAL CABLING SYSTEM FOR IN-BUILDING APPLICATIONS

(71) Applicant: 3M INNOVATIVE PROPERTIES COMPANY, St. Paul, MN (US)

(72) Inventors: Stephen Paul LeBlanc, Austin, TX (US); Kurt H. Petersen, Austin, TX (US); Curtis L. Shoemaker, Round Rock, TX (US)

(21) Appl. No.: 14/114,712

(22) PCT Filed: Apr. 24, 2012
(86) PCT No.: PCT/US12/34782

§ 371 Date: Oct. 29, 2013

Related U.S. Application Data
(60) Provisional application No. 61/486,569, filed on May 16, 2011.

(51) Int. Cl. H02G 3/04

(52) U.S. Cl. CPC H02G 3/04
USPC 174/95

(57) ABSTRACT

An adhesive-backed duct has a main body having a conduit portion with a cavity formed longitudinally therethrough and a flange portion having an adhesive backing layer to mount the duct to a mounting surface. A septum is disposed within the cavity portion and defines at least two bore potions.

### BACKGROUND OF THE INVENTION

1. Field of the Invention

The present invention is directed to adhesive-backed cabling for in-building wireless or fiber to the home horizontal cabling applications.

2. Background

More than half of all mobile communications originate from inside buildings. With the development of 3G and 4G smart phones and other data intensive mobile devices, increasing demand is being placed on wireless and wired infrastructure within buildings such as office buildings, schools, hospitals, and residential units. Better wired and wireless communication coverage is needed to provide the desired bandwidth to an increasing number of customers. However, the labor to install these enhanced wired and wireless systems in existing buildings can be costly, so a low cost and easy to install structured cabling solution to enhance wired and/or wireless coverage within a building is needed.

In-Building Wireless (IBW) Distributed Antenna Systems (DASs) are utilized to improve wireless coverage within buildings and related structures. Conventional DASs use strategically placed antennas or leaky coaxial cable (leaky coax) throughout a building to accommodate radio frequency (RF) signals in the 300 MHz to 6 GHz frequency range. Conventional RF technologies include TDMA, CDMA, WCDMA, GSM, UMTS, PCS/cellular, iDEN, and many others. Additional wireless signals which use an in-building wireless network can also include telemetry, WiFi, and public safety signals.

Conventional wired communications systems include enterprise grade Passive Optical Networks (PONs) and Ethernet over twisted pairs or optical fibers. Wired cabling can also be used for remote powering of optical fiber fed wireless access points and remote radios for the in building wireless system.

Outside the United States, carriers are required by law in some countries to extend wireless coverage inside buildings. In the United States, bandwidth demands and safety concerns will drive IBW applications, particularly as the world moves to current 4G architectures and beyond.

There are a number of known network architectures for distributing wireless communications inside a building. These architectures include choices of passive, active and hybrid systems. Active architectures generally include manipulated RF signals carried over fiber optic cables to remote electronic devices which reconstitute the electrical signal and transmit/receive the signal. Passive architectures include components to radiate and receive signals, usually a coaxial cable attached to discrete antennas or through a punctured shield leaky coax network. Hybrid architectures include native RF signal carried optically to active signal distribution points which then feed multiple coaxial cables terminating in multiple transmit/receive antennas. Specific examples include analog/amplified RF, RoF (Radio over Fiber, also known as RFoG, or RF over glass), fiber backhaul to pico and femto cells, and RoF vertical or riser distribution with an extensive passive coaxial distribution from a remote unit to the rest of the horizontal cabling (within a floor, for example). These conventional architectures can have limitations in terms of electronic complexity and expense, inability to easily add services, inability to support all combinations of services, distance limitations, or cumbersome installation requirements.

Conventional cabling for IBW applications includes RADIAFLEX™ cabling available from RFS (www.rfsworld.com), standard ½ inch coax for horizontal cabling, ⅞ inch coax for riser cabling, as well as standard optical fiber cabling for riser and horizontal distribution.

Physical and aesthetic challenges exist in providing IBW cabling for different wireless network architectures, especially in older buildings and structures. These challenges include gaining building access, limited distribution space in riser closets, and space for cable routing and management.

### SUMMARY

According to an exemplary aspect of the present invention, an adhesive-backed duct has a main body having a conduit portion with a cavity formed longitudinally therethrough a flange portion having an adhesive backing layer to mount the duct to a mounting surface. A septum is disposed within the cavity portion and defines at least two bore potions.

In another exemplary aspect, an adhesive-back cabling structure is described that comprises an adhesive-backed duct, and at least one communication line (i.e. a coaxial cable, a twisted pair of copper wires or an optical fiber) disposed within each of the at least two bore portions. The adhesive-backed duct has a main body having a one conduit portion with a cavity formed longitudinally therethrough a flange portion having an adhesive backing layer to mount the duct to a mounting surface. A septum is disposed within the cavity portion and defines at least two bore potions. The cabling structure can further include a pair of power lines.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIGS. 1A-1D are four isometric views of a first exemplary adhesive-backed duct in accordance with an aspect of the present invention;

FIGS. 2A-2B are two alternative isometric views of a second exemplary adhesive-backed duct in accordance with an aspect of the present invention;

FIGS. 3A and 3B are two isometric views of two additional exemplary adhesive-backed ducts in accordance with another aspect of the present invention;

FIG. 4 is an isometric view of another exemplary adhesive-backed duct in accordance with another aspect of the present invention;

FIG. 5 is an isometric view of another exemplary adhesive-backed duct in accordance with another aspect of the present invention; and

FIG. 6 shows an exemplary use of a re-enterable cabling structure in accordance with an aspect of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a re-enterable cabling system comprising a duct for in-building wireless (IBW) and wireline applications. The inventive cabling solutions described herein provide multiple signal pathways for coaxial (coax) cables, twin axial (twinax) cable, optical fibers, and power distribution cabling. The re-enterable cabling system is designed with a low impact profile for better aesthetics and can provide for multiple channels of RF/cellular or data traffic to be distributed within a building or premises location such as a single family home, multi-dwelling unit or apartment building, an office building, a hospital, or a university, for example.

These multiple signal pathways can be dedicated to different carriers, with each carrier needing wireless distribution within a building, or to providing different services such as data transmission. These multiple signal pathways can also be dedicated to routing signals to different locations within a building. The inventive cabling system may be used above the ceiling or below the ceiling. Thus, the re-enterable cabling structure enables flexible network design and optimization for a given indoor environment.

The cabling structure can be designed to accommodate most small forms of optical fiber or electrical cables. For example, the cable tracks within the cabling structure may be sized to accommodate one of a copper ribbon cable, a fiber ribbon cable, a twin ax cable, a micro-coax cable, a twisted pair cable such as a CAT 5e cable or a CAT 6 cable, a coated wire, an optical fiber drop cable or a 900 micron coated optical fiber.

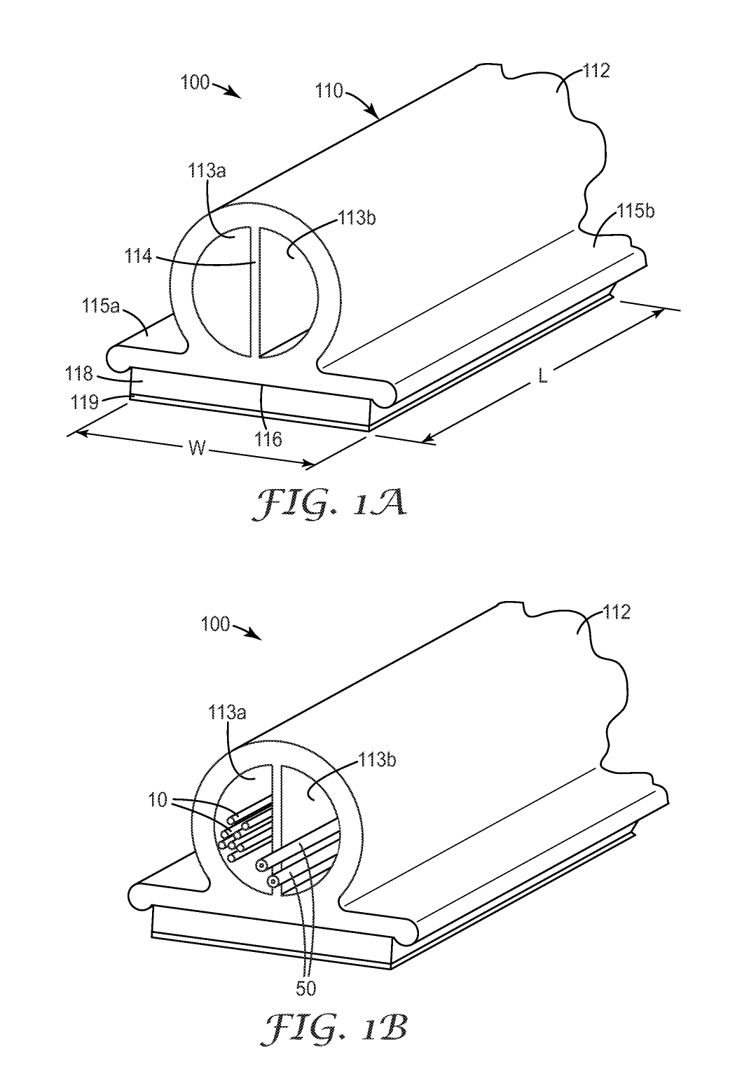

In a first aspect of the invention, an adhesive-backed cabling duct 100 accommodates one or more RF signal channels to provide horizontal cabling for IBW applications or optical fibers to support a fiber to the home network. As shown in FIG. 1A, duct 100 includes a main body 110 having a conduit portion 112 with a cavity provided therethrough. The cavity can be divided by a septum 114 to form two bore portions 113a, 113b extending through the conduit potion. The separate bore portions can enable craft separation between fiber and copper, for example, or network separation (for example, if the bore portion 113a holds optical fibers for wireless signal distribution and bore portion 113b holds optical fibers for wireline (GPON, Ethernet, etc.) networks.

Each bore portion 113a, 113b is sized to accommodate one or more optical fibers and/or insulated electrical wires such as RF communication lines or conventional copper twisted pair communication lines. These RF communication lines, as explained further below, can include coax cables, optical fibers, and/or power lines. In use, the duct 100 can be pre-populated with one or more coax cables, optical fibers, and/or power lines. In a preferred aspect, the RF communication lines are configured to transmit RF signals, having a transmission frequency range from about 300 MHz to about 6 GHz.

Advantageously, septum 114 can provide some vertical support for the central cavity extending through conduit portion 112 of duct 100. When duct 100 is bent around an in-plane corner, septum 114 will be disposed along the neutral axis of the in-plane bend.

While the cavity formed within the conduit portion 112 of the exemplary adhesive-backed duct can have a generally circular cross-section, in alternative embodiments it may have another shape, such as a rectangular, square, triangular, oval, or other polygonal shaped cross-section.

In addition, while septum 114 is shown in FIG. 1 as vertically bisecting the cavity formed within the conduit portion to form two semi-cylindrical bore portions, the septum may divide the cavity into unequally sized bore portions or the septum may be horizontally disposed within the cavity formed within the conduit portion. In another aspect, the adhesive-backed duct can have two septa formed within the cavity formed within the conduit portion. These septa can be oriented parallel to one another or may intersect to form more than two bore portions extending through the conduit potion of the adhesive back duct. In another alternative aspect, the adhesive-backed duct can have more than two septa formed within the cavity formed within the conduit portion as dictated by the needs of the network in which it is to be installed.

In one aspect, duct 100 is a structure formed from a polymeric material, such as a polyolefin, a polyurethane, a polyvinyl chloride (PVC), or the like. For example, in one aspect, duct 100 can comprise an exemplary material such as a polyurethane elastomer, e.g., Elastollan 1185A10FHF. Additives, such as flame retardants, stabilizers, and fillers can also be incorporated as required for a particular application. In a preferred aspect, duct 100 is flexible, so that it can be guided and bent around corners and other structures without cracking or splitting. Duct 100 can be continuously formed using a conventional extrusion process.

Duct 100 also includes a flange or similar flattened portion to provide support for the duct 100 as it is installed on or mounted to a wall or other mounting surface, such as a floor, ceiling, or molding. In most applications, the mounting surface is generally flat. The mounting surface may have texture or other structures formed thereon. In other applications, the mounting surface may have curvature, such as found with a pillar or column. The flange extends along the longitudinal axis of the duct as shown in FIG. 1A. Exemplary duct 100 includes a double flange structure, with flange portions 115a and 115b, positioned below the centrally positioned conduit portion. In an alternative aspect, the flange can include a single flange portion. In alternative applications, a portion of the flange can be removed for in-plane and out-of-plane bending.

In a preferred aspect, the flange 115a, 115b includes a rear or bottom surface 116 that has a generally flat surface shape. This flat surface provides a suitable surface area for adhering the duct 100 to a mounting surface, a wall or other surface (e.g., dry wall or other conventional building material) using an adhesive layer 118.

Optionally, duct 100 can include one or more strength members (not shown), such as an aramid string or thread (e.g., a woven or non-woven Kevlar material) that is twisted or aramid yarn. The aramid string or aramid yarn can be bonded or un-bonded. Alternative strength member materials include metallic wire or a fiberglass member. The strength member can run lengthwise with the main body of duct 100 and can be disposed between the bottom surface 116 (of the duct's main body and/or flange 115a/115b) and adhesive layer 118. Alternatively, the strength member(s) can be disposed within one or both of bore portions 113a. The strength member(s) can help prevent elongation and relaxation of the duct during and after installation, where such elongation and relaxation may cause debondment of the duct from the mounting surface.

In a preferred aspect of the present invention, the adhesive layer 118 comprises an adhesive, such as an epoxy, transfer adhesive, acrylic adhesive or double-sided tape, disposed on all or at least part of surface 116. In one aspect, adhesive layer 118 comprises a factory applied 3M VHB 4941F adhesive tape (available from 3M Company, St. Paul Minn.). In another aspect, adhesive layer 118 comprises a removable adhesive, such as a stretch release adhesive. By “removable adhesive” it is meant that the duct 100 can be mounted to a mounting surface (preferably, a generally flat surface, although some surface texture and/or curvature are contemplated) so that the duct 100 remains in its mounted state until acted upon by an installer/user to remove the duct from its mounted position. Even though the duct is removable, the adhesive is suitable for those applications where the user intends for the duct to remain in place for an extended period of time. Suitable removable adhesives are described in more detail in PCT Patent Publication No. WO 2011/129972, incorporated by reference herein in its entirety.

In an alternative aspect, adhesive layer 118 includes a removable liner 119. In use, the liner 119 can be removed and the adhesive layer can be applied to a mounting surface.

While many of the ducts described herein are shown having a symmetrical shape, the duct designs can be modified to have an asymmetric shape (such as a flange wider on one side than the other), as would be apparent to one of ordinary skill in the art given the present description.

Moreover, the ducts described herein may be coextruded with at least two materials. A first material can exhibit properties that afford protection of the communication lines or other cables within the conduit portion of each duct such as against accidental damage due to impact, compression, or even provide some protection against intentional misuse such as stapling. A second material can provide functional flexibility for cornering.

In some aspects, the ducts can include a VO flame retardant material, can be formed from a material that is paintable, or in a further alternative, covered with another decorative material.

In a preferred aspect, adhesive backed duct 100 can be extruded around the communication lines (coax cables, twisted pair copper wires, optical fibers, and/or power lines) to be contained therein.

In one exemplary aspect shown in FIG. 1B, adhesive backed duct 100 can have one or more optical fibers disposed in a first of the bore portion 113a extending the conduit portion 112 and one or more electrical conductors (e.g. coax cables, twisted pair copper wires, and/or power lines) disposed in a second of the bore portion 113b extending the conduit portion. In the exemplary aspect shown in FIG. 1B, eight optical fibers 10 are disposed in bore portion 113a and two power lines 50 are disposed in bore portion 113b. The exemplary adhesive backed duct can be sized to carry two, four, eight, twelve, sixteen, or twenty-four optical fiber as required for a particular network configuration.

In an alternative exemplary aspect shown in FIG. 1C, adhesive backed duct 100 can have one or more optical fibers and one or more electrical conductors disposed in a first of the bore portions 113a extending the conduit portion 112 and similarly one or more optical fibers 10 and one or more electrical conductors 50 disposed in a second of the bore portions 113b extending the conduit portion. In the exemplary aspect shown in FIG. 1C, four optical fibers 10 and two power lines 50 are disposed in each bore portion 113a, 113b.

In an alternative exemplary aspect shown in FIG. 1D, adhesive backed duct 100 can have one or more optical fibers disposed in each of the bore portions 113a, 113b extending the conduit portion 112. In the exemplary aspect shown in FIG. 1D, eight optical fibers 10 are disposed in a first bore portion 113a, and four optical fibers 10 are disposed in a second bore portion 113b.

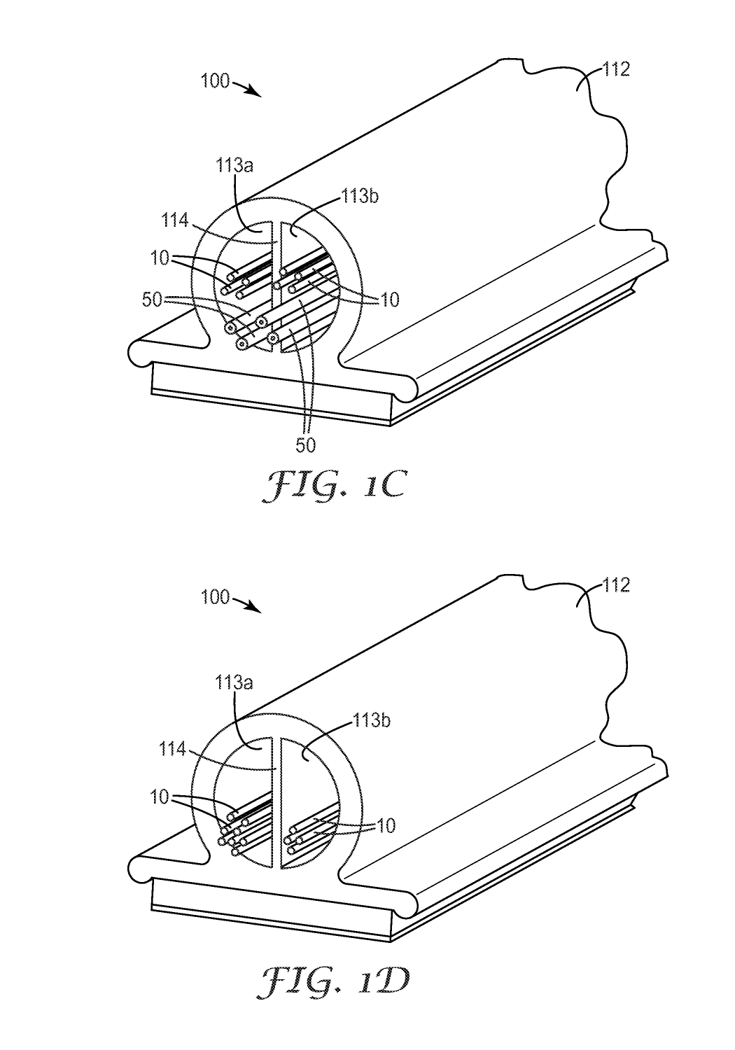

In a second aspect of the invention, an adhesive-backed cabling duct 200 accommodates one or more RF signal channels to provide horizontal cabling for IBW applications or optical fibers to support a fiber to the home network. As shown in FIG. 2A, duct 200 includes a main body 210 having a conduit portion 212 with a cavity provided therethrough. The cavity can be divided by a septum 214 to form two bore portions 213a, 213b extending through the conduit potion. Each bore portion 213a, 213b is sized to accommodate one or more communication lines (RF communication lines, copper communication lines or optical fiber communication lines) to support an IBW and/or a wired communication network. In use, the duct 200 can be pre-populated with one or more coax cables, copper communication lines, optical fibers, and/or power lines. In a preferred aspect, the RF communication lines are configured to transmit RF signals, having a transmission frequency range from about 300 MHz to about 6 GHz.

Duct 200 can include one or more lobed portions 220a, 220b formed in septum 214. Each lobed portion can have an auxiliary bore 222a, 222b formed therethrough. The auxiliary bores can carry strength members or embedded power lines. FIG. 2B shows duct 200 having two power lines 50 disposed within the auxiliary bores 222a, 222b. The power lines 50 can be insulated or non-insulated electrical wires, (e.g. copper wires). The power lines can provide low voltage DC power distribution for remote electronics (such as remote radios or WiFi access points) that are served by this structured cable. When power lines 50 are embedded in the septum 214, the power lines can act as a strength member to prevent the duct 200 from stretching during installation. The power lines 50 within the septum could be accessed by an IDC type of connection (not shown) by making a window cut in the conduit portion 212 of duct 200. Embedding the power lines in the septum allows the location of the wires to be known and fixed facilitating the use of IDC or other connectors to make electrical connections to the power lines.

The separate bore portions 213a, 213b can be populated with optical fibers or insulated wires as described previously. The separate bore portions enable craft separation between fiber and copper, or network separation.

Duct 200 also includes a flange or similar flattened portion to provide support for the duct 200 as it is installed on or mounted to a wall or other mounting surface, such as a floor, ceiling, or molding. Duct 200 includes a double flange structure, with flange portions 215a and 215b, positioned below the centrally positioned conduit portion. In an alternative aspect, the flange can include a single flange portion. In alternative applications, a portion of the flange can be removed for in-plane and out-of-plane bending.

In a preferred aspect, the flange 215a, 215b includes a rear or bottom surface 216 that has a generally flat surface shape. This flat surface provides a suitable surface area for adhering the duct 200 to a mounting surface, a wall or other surface (e.g., dry wall or other conventional building material) using an adhesive layer 218. Adhesive layer 218 can comprises an adhesive as described previously. In an alternative aspect, adhesive backing layer 218 includes a removable liner 219. In use, the liner 219 can be removed and the adhesive layer can be applied to a mounting surface.

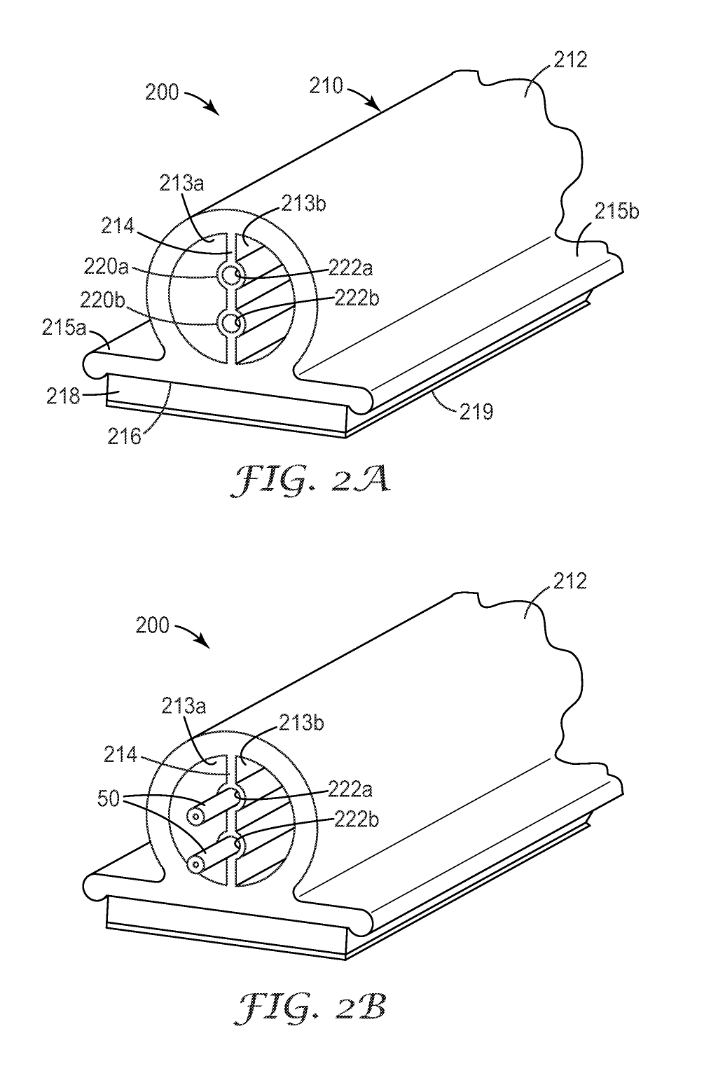

In a another aspect of the invention, an adhesive-backed cabling duct 300 accommodates one or more RF signal channels to provide horizontal cabling for IBW applications or optical fibers to support a fiber to the home network. As shown in FIG. 3A, duct 300 includes a main body 310 having a conduit portion 312 with a cavity provided therethrough. The cavity can be divided by a septum 314 to form two bore portions 313a, 313b extending through the conduit potion as described with respect to duct 200 shown in FIG. 2A.

Duct 300 further includes longitudinal seams 330a, 330b through conduit portion 312 and into bore portions 313a, 313b. The longitudinal seams 330a, 330b allow the interior of bore portions 313a, 313b to be accessed without use of a tool. The structure of the longitudinal seams allows the bore portions to be opened for access to the communication lines contained therein and closed a number of times without use of a tool (such as a knife). The structure of the longitudinal seam can provide a latching mechanism 340 that allows the duct chambers to be held closed until access is required.

In the exemplary aspect shown in FIG. 3A, latching mechanism 340 includes a v-groove structure 342a, 342b formed on a top surface of each of the flanges 315a, 315b. The v-groove structure 342a, 342b configured to engage the free end 312a, 312b of body portion 312 in a closed configuration. To access the communication lines within the bore portions 313a, 313b, free end 312a, 312b of body portion 312 are removed from v-groove structure 342a, 342b.

In another exemplary aspect shown in FIG. 3B, the longitudinal seam structure may be composed of a longitudinal slit 330a′, 330b′ in the wall of conduit portion 312′ of adhesive back duct 300′. While the longitudinal slits may not have a specific latching mechanism, this single slit seam structure may have manufacturing advantages. The slit could be formed when the duct is extruded, or could be cut into cut into the sidewalls of the bore portions after the duct extrusion process.

In ducts having a longitudinal seam such as duct 300′, it may be advantageous to increase the thickness of septum 314′ since the septum is now responsible for the connection of the conduit portion 312′ to the rest of the duct structure.

In the exemplary aspect shown in FIGS. 3A and 3B, ducts 300, 300′ can be extruded separately from the communication lines to be held in bore portions 313a, 313a′, 313b, 313b′. After extrusion of duct 300, 300′ and in a later manufacturing step, bore portions 313a, 313a′, 313b, 313b′can be populated with any mix and match of electrical and optical fiber communication lines. Duct 300, 300′ provides for flexibility in manufacturing allowing several different product offerings to be made from a common duct structure.

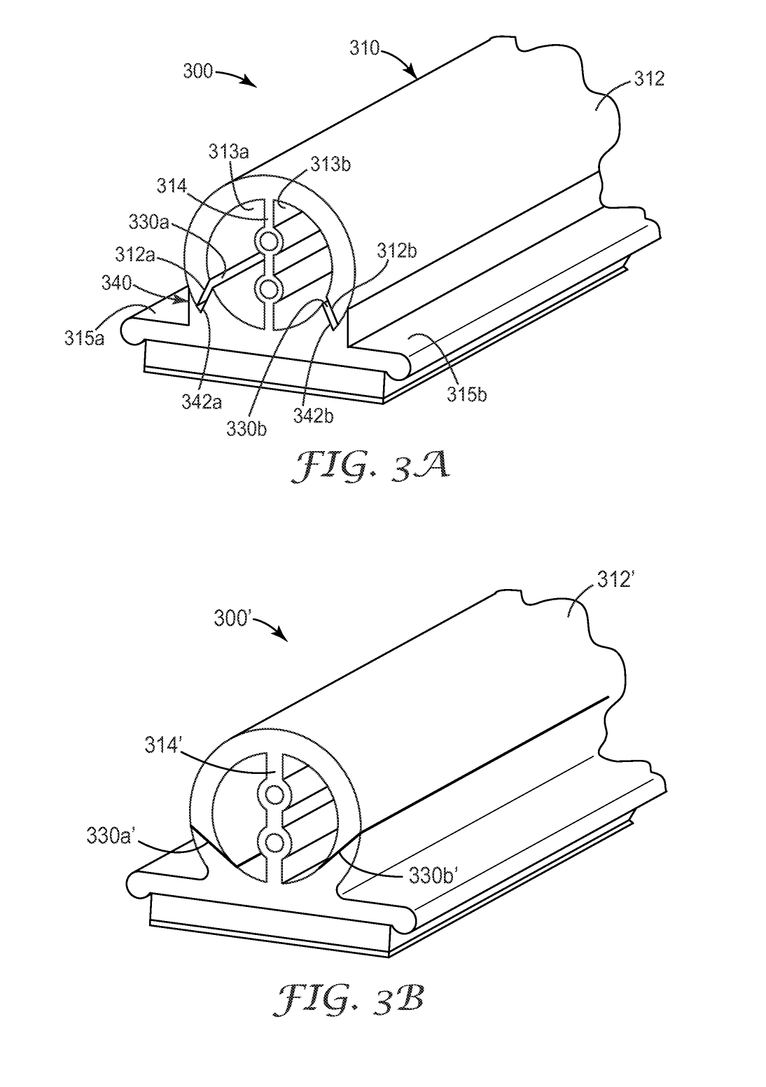

In another aspect of the invention shown in FIG. 4, an adhesive-backed cabling duct 400 accommodates one or more communication lines for IBW network and/or wired communication. Duct 400 includes a main body 410 having a conduit portion 412 with a cavity provided therethrough. The cavity can be divided by a pair of spaced apart septa 414a, 414b to form two bore portions 413a, 413b extending through the conduit potion. Each bore portion 413a, 413b is sized to accommodate one or more communication lines (RF communication lines, copper communication lines or optical fiber communication lines) to support an IBW and/or a wired communication network. In use, the duct 410 can be pre-populated with one or more coax cables, copper communication lines, optical fibers, and/or power lines.

Duct 400 can include one or more lobed portions 420a, 420b formed between septa 414a, 414b. Each lobed portion can have an auxiliary bore 422a, 422b formed therethrough. The auxiliary bores can carry strength members or embedded power lines. If power lines are disposed on auxiliary bores 413a, 413b, the power lines can be insulated or non-insulated electrical wires, (e.g. copper wires). The power lines can provide low voltage DC power distribution for remote electronics (such as remote radios or WiFi access points) that are served by this structured cable. Power lines disposed within auxiliary bore 422a, 422b can be accessed by an IDC type of connection (not shown) by making a window cut in the conduit portion 412 of duct 400. Embedding the power lines in the septum allows the location of the wires to be known and fixed, facilitating the use of IDC or other connectors to make electrical connections to the power lines.

In another exemplary aspect, insulated power lines can be free floating between a pair of spaced apart septa similar to the spaced apart septa 414a, 414b shown in FIG. 4 effectively giving the duct 3 individual bore portions. Alternatively, select fibers could also be located in the third bore portion formed between the two spaced apart septa. This middle chamber has the benefit that it is on the neutral axis of the duct when the duct is bent around in-plane corners. As such, fibers within the third bore portion would not be under compression or tension as they go through an in-plane corner.

Duct 400 also includes a flange or similar flattened portion to provide support for the duct 400 as it is installed on or mounted to a wall or other mounting surface, such as a floor, ceiling, or molding. Duct 400 includes a double flange structure, with flange portions 415a and 415b, positioned below the centrally positioned conduit portion. In an alternative aspect, the flange can include a single flange portion. In alternative applications, a portion of the flange can be removed for in-plane and out-of-plane bending.

In a preferred aspect, the flange portions 415a, 415b includes a rear or bottom surface 416 that has a generally flat surface shape. This flat surface provides a suitable surface area for adhering the duct 400 to a mounting surface, a wall or other surface (e.g., dry wall or other conventional building material) using an adhesive layer 418. Adhesive layer 418 can comprises an adhesive as described previously. In an alternative aspect, adhesive backing layer 418 includes a removable liner 419. In use, the liner 419 can be removed and the adhesive layer can be applied to a mounting surface.

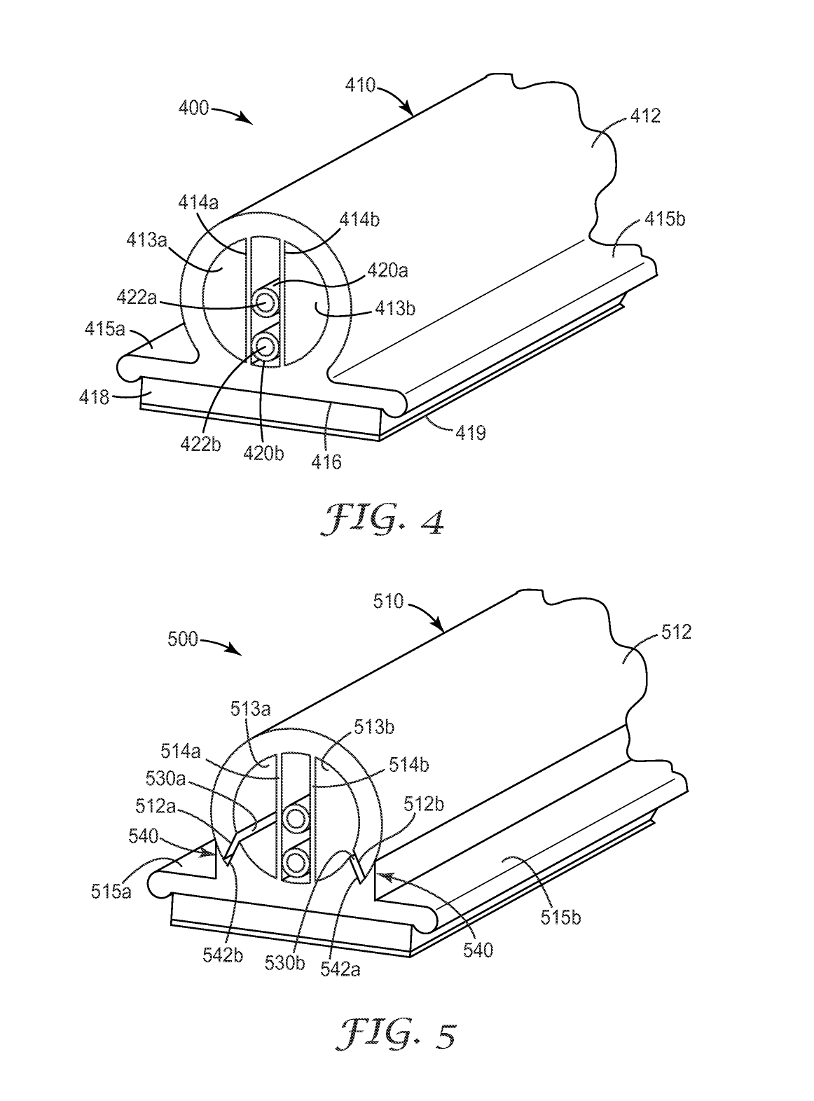

In another aspect of the invention shown in FIG. 5, an adhesive-backed cabling duct 500 accommodates one or more RF signal channels to provide horizontal cabling for IBW applications or optical fibers to support a fiber to the home network. As shown in FIG. 5, duct 500 includes a main body 510 having a conduit portion 512 with a cavity provided therethrough. The cavity can be divided by a pair of spaced apart septa 514a, 514b to form two bore portions 513a, 513b extending through the conduit potion as described with respect to duct 400 shown in FIG. 4.

Duct 500 further includes longitudinal seams 530a, 530b through conduit portion 512 and into bore portions 513a, 513b. The longitudinal seams 530a, 530b allow the interior of bore portions 513a, 513b to be accessed without use of a tool. The structure of the longitudinal seams allows the bore portions to be opened for access to the communication lines contained therein and closed a number of times without use of a tool (such as a knife). The structure of the longitudinal seam can provide a latching mechanism 540 that allows the duct chambers to be held closed until access is required.

In the exemplary aspect shown in FIG. 5, latching mechanism 540 includes a v-groove structure 542a, 542b formed on a top surface of each of the flanges 515a, 515b. The v-groove structure 542a, 542b configured to engage the free end 512a, 512b of body portion 512 in a closed configuration. To access the communication lines within the bore portions 513a, 513b, free end 512a, 512b of body portion 512 are removed from v-groove structure 542a, 542b.

In another exemplary aspect, the longitudinal seam structure may be composed of a single slit in the sidewall of the each bore portion 513a and 513b. Although a specific latching mechanism is not present, this single slit seam structure is easier to manufacture. The slit could be extruded, or cut into the sidewall after the duct extrusion process.

In the exemplary aspect shown in FIG. 5, duct 500 can be extruded separately from the communication lines to be held in bore portions 513a, 513b. After extrusion of duct 500 and in a later manufacturing step, bore portions 513a, 513b can be populated with any mix and match of electrical and optical fiber communication lines. Duct 500 provides for flexibility in manufacturing allowing several different product offerings to be made from a common duct structure.

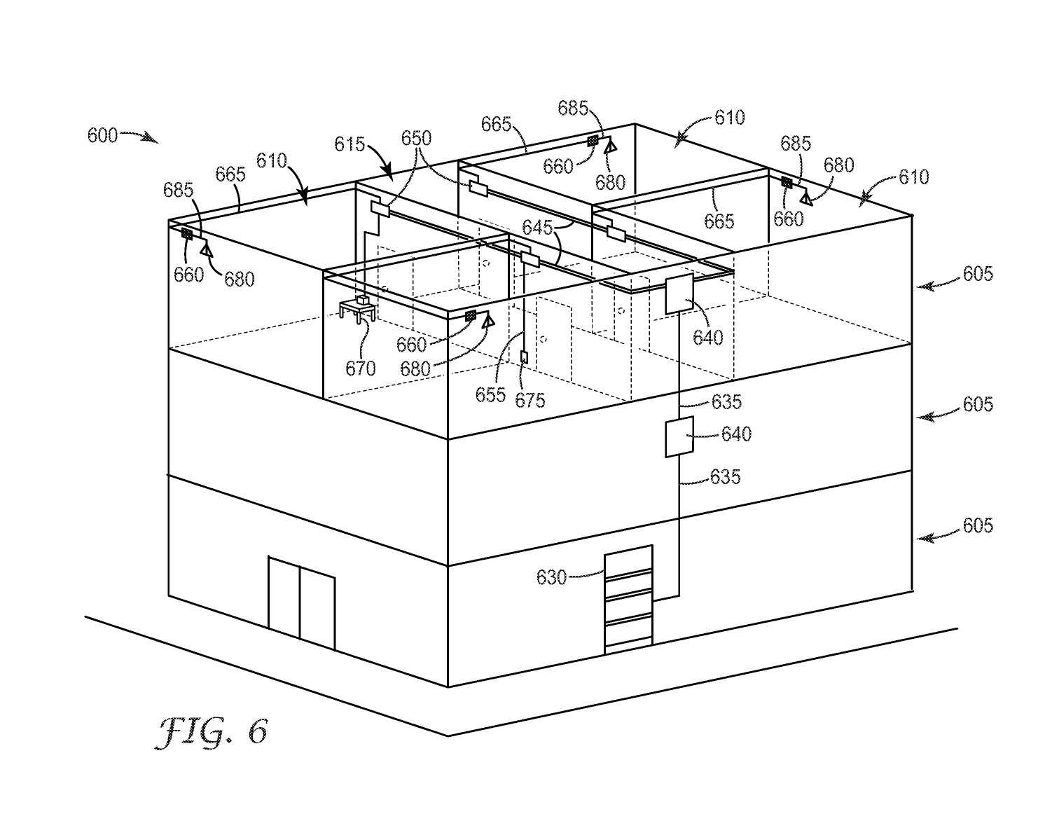

In one exemplary use, the adhesive-backed duct, described herein, can be used as part of a converged in-building wired and wireless system as shown in FIG. 6. In this system, the adhesive-backed duct can be used as horizontal cabling 645 between area junction boxes or distribution boxes located on each floor and the point of entry boxes located at one or more access points 650, such as at or near the entryway of a living unit. Additionally, the adhesive-backed ducts of the current disclosure can be used as wireless cabling 665 to carry multiple optical fiber plus power cables within each living unit from the point of entry box to a remote radio socket located near each of the distributed antennas.

For example, FIG. 6 shows an exemplary multi-dwelling unit (MDU) 600 having four living units 610 on each floor 605 within the building with two living units located on either side of a central hallway 615.

A feeder cable (not shown) brings wired communications lines to and from building 600 from the traditional communication network and coax feeds bring the RF or wireless signals into the building from nearby wireless towers or base stations. All of the incoming lines (e.g. optical fiber, coax, and traditional copper) are fed into a main distribution facility in the basement or equipment closet of the MDU, which is used to organize the signals coming into the building from external networks to the centralized active chassis equipment for the system. Power mains and backup power is typically configured in this main distribution facility. Additionally, fiber and power cable management which supports the indoor wired and wireless networks both into the building from the outside plant and onto the rest of the indoor network distribution system can be located in the main distribution facility. The main distribution facility can include one or more racks 630 to hold equipment chassis as well as telecommunication cable management modules. Exemplary equipment which can be located on the rack in the main distribution facility can include, for example, a plurality of RF signal sources, an RF conditioning drawer, a DAS hub, a power distribution equipment, and DAS remote management equipment. Exemplary telecommunication cable management modules can include, for example, a fiber distribution hub, a fiber distribution terminal or a patch panel.

Riser cables or trunk cables 635 run from the equipment rack 630 in the main distribution facility to the area junction boxes 640 located on each floor 605 of the MDU 600. The area junction box provides the capability to aggregate horizontal fiber runs and optional power cabling on each floor. At the area junction box, trunk cabling can be broken out into a number of inventive cabling structures containing optical fibers or other communication cables and power cables, described herein. As mentioned previously, the exemplary populated adhesive back duct structures or cabling can act as horizontal cabling 645 within the MDU carrying the wired and wireless signals through a variety of interface boxes such as a point of entry box, an access box or an additional distribution box to the antennas. A point of entry box 650 can be located at each living unit to split off power and communication cables to be used within a given living unit 610.

These cables feed remote radio sockets 660 as well as connections to communication equipment 670 inside of each living unit or a wall receptacle 675 to which a piece of communication equipment can be connected by a patchcord (not shown) through point of entry boxes 650. Exemplary communication equipment can include a single family unit optical network terminal (SFU ONT), desktop ONT, or similar device (e.g., a 7342 Indoor Optical Terminal, available from Alcatel-Lucent or a Motorola ONT1120GE Desktop ONT).

The optical fibers and power cables contained within the exemplary duct structure can feed the remote radio socket in a second smaller (i.e. lower cable count) wireless cabling structure 655.

The remote radio socket can include remote repeater/radio electronics to facilitate a common interface between the active electronics and the structured cabling system. The remote radio socket facilitates plugging in the remote radio electronics which convert the optical RF to electrical signals and further distributes this to the distributed antennas 680 for radiation of the analog RF electrical signal for the in building wireless distribution system.

The distributed antennas 680 can be connected to the remote radio socket 660 by a short length of coaxial fiber 685.

Optical drop fibers can be carried from the point of entry box 650 to an anchor point, such as wall receptacle 675 or a piece of communication equipment 670, via low profile duct 655. In a preferred aspect, the duct 655 can be disposed along a wall, ceiling, under carpet, floor, or interior corner of the living unit in an unobtrusive manner, such that the aesthetics of the living unit are minimally impacted. Exemplary low profile ducts are described in U.S. Patent Publications Nos. 2011-0030832 and 2010-0243096, incorporated by reference herein in their entirety.

In one exemplary aspect, the exemplary adhesive-backed duct can include a first RF signal carrying cable disposed in a first cable track to carry an RF signal from a first wireless service provider and a second RF signal carrying cable disposed in a second cable track to carry an RF signal from a second wireless service provider.

The cabling system described above can be used with RoF DAS, split radio, software defined radio, pico cell, and femto cell in-building wireless networks. In particular, the cabling system can use the inventive cabling structure in a distributed antenna system that can be mounted to a vertical mounting surface such as a wall or a horizontal mounting surface such as a ceiling via the optional adhesive backing layer or can be installed above the ceiling without the additional adhesive backing layer. In an exemplary installation, the cabling structure can be mounted to the wall of the building just below the ceiling.

In one exemplary use, the cabling structure described herein can be used as part of a passive copper coax distribution architecture. In this architecture, some of the cable tracks of the cabling structure can be filled with coax cables (e.g. standard coax cables, micro-coax cables or twinax coax cables) with only a head-end active component. The cabling structure will provide the communication conduit between the active head end component and the antennas distributed throughout the building. Thus, this system can be implemented to connect the discrete distributed antennas to the horizontal coax channels with conventional splitters, taps, and/or couplers. In this manner, multiple service carriers can utilize the adhesive-backed cabling structure as horizontal cabling. This type of architecture can work with many different RF protocols (e.g., any cellular service, iDEN, Ev-DO, GSM, UMTS, CDMA, and others).

In one alternative aspect, the exemplary cabling structure can include multiple coax cables. For example, separate coax conductors can connect to separate antennas of a multiple-input and multiple-output (MIMO) antenna system, e.g., a 2×2 MIMO antenna system, a 4×4 MIMO antenna system, etc. In another alternative aspect, first and second coax conductors can be coupled to a single antenna system with cross-polarized antenna elements.

In another example, the exemplary cabling structure described herein can be used as part of an active analog distribution architecture. In this type of architecture, RF signal distribution can be made over coax or fiber (RoF). In this architecture, the cabling structure can be combined with selected active components, where the types of active components (e.g., O/E converters for RoF, MMIC amplifiers) are selected based on the specific architecture type. This type of architecture can provide for longer propagation distances within the building and can work with many different RF protocols (e.g., any cellular service, iDEN, Ev-DO, GSM, UMTS, CDMA, and others).

The exemplary cabling structure described above can be used in buildings where there are a lack of established horizontal pathways from main distribution boxes to distributed antennas or end user dwellings. For buildings with drywall ceilings and few or no access panels, the adhesive-backed cabling structure of the present invention can be installed without having to enter the existing drywall ceiling by attaching it to a wall or ceiling in an inconspicuous manner. For installations in older buildings in which the blueprints are missing or inaccurate, the adhesive-backed cabling structure can be installed on the basis of a visual survey. Additionally, the adhesive-backed cabling structure, described herein, can minimize or eliminate the need to disturb existing elaborate trim and hallway decorum. In addition, the need to establish major construction areas can be avoided.

The adhesive-backed cabling structure can provide for routing signals to different locations within a building, such as “lunch room,” “conference room,” “meeting room”, etc. The mix and match cable options allows for a separate channel or signal pathways to be set up independent of the other channels, if needed. This type of configuration can provide enhanced signal transmission to key locations within the building without affecting other channels.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. A adhesive-backed duct, comprising:
a main body having a conduit portion with a cavity formed longitudinally therethrough;
a septum disposed within the cavity portion and defining at least two bore potions; and
a flange portion having an adhesive backing layer to mount the duct to a mounting surface.

2. The duct of claim 1, wherein the septum is vertically disposed within the cavity.

3. The duct of claim 1, wherein the septum is horizontally disposed within the cavity.

4. The duct of claim 1, wherein the duct has a pair of spaced apart septa disposed within the cavity.

5. The coaxial cable of claim 1, wherein the adhesive layer comprises a pressure sensitive adhesive.

6. The coaxial cable of claim 1, wherein the adhesive layer comprises a repositionable adhesive.

7. The duct of claim 1, further comprising at least one lobed portion formed in the septum.

8. The duct of claim 7, wherein each lobed portion includes an auxiliary bore formed therethrough.

9. The duct of claim 1, wherein the duct is formed from a flexible material such that it can be bent around a curved surface.

10. The duct of claim 1, further comprising a longitudinal seam to access the interior of each bore portion.

11. The duct of claim 10, further comprising a latching mechanism to engage the free end of the conduit portion.

12. The duct of claim 11, wherein the latching mechanism includes a v-groove structure formed on a top surface of the flange.

13. The adhesive-backed duct of claim 1, further comprising at least one communication line disposed within at least one of the two bore portions.

14. The cabling structure of claim 13, further comprising two power lines.

15. The cabling structure of claim 1, wherein the at least one communication line is disposed in a first of the at least two bore portions and the power lines are disposed in a second of the at least two bore portions.

16. The cabling structure of claim 14, wherein each of the at least two bore portions includes a plurality of communication lines and two power lines.

17. The cabling structure of claim 1, further comprising two lobed portions formed in the septum, wherein each of the lobed portions includes an auxiliary bore formed therethrough.

18. The cabling structure of claim 8, further comprising a strength member disposed in each of the auxiliary bores.

19. The cabling structure of claim 17, further comprising a power line disposed in each of the auxiliary bores.

20. The cabling structure of claim 13 wherein the at least one communication line is one of a coaxial cable, a twisted pair copper wire or an optical fiber.
